(19) United States
(12) Patent Application Publication
(10) Pub. No.: US 2025/0355843 A1
(43) Pub. Date: Nov. 20, 2025

(54) GENERATING CATEGORICAL DATA FOR MISSING VALUES IN ANOMALY DETECTION SYSTEMS

(71) Applicant: NEC Laboratories America, Inc., Princeton, NJ (US)

(72) Inventors: Peng Yuan, Plainsboro, NJ (US); LuAn Tang, Cranbury, NJ (US); Haifeng Chen, West Windsor, NJ (US); Motoyuki Sato, Cupertino, CA (US); Yanchi Liu, Princeton, NJ (US)

(21) Appl. No.: 19/199,922

(22) Filed: May 6, 2025

Related U.S. Application Data
(60) Provisional application No. 63/648,747, filed on May 17, 2024.

(51) Int. Cl. G06F 16/215

(52) U.S. Cl. CPC G06F 16/215

(57) ABSTRACT

Systems and methods for generating categorical data for missing values in anomaly detection systems. In an embodiment, irregular time-series data can be aligned into regular time-series data by utilizing a generated timestamp sequence to obtain aligned time-series data. Missing values from the aligned time-series data can be filled with generated categorical time-series data. Anomaly detection can be performed for the cyber-physical system to obtain system anomalies. A corrective action can be performed to resolve issues with the cyber-physical system caused by the system anomalies.

### RELATED APPLICATION INFORMATION

This application claims priority to U.S. Provisional App. No. 63/648,747, filed on May 17, 2024, incorporated herein by reference in its entirety.

### BACKGROUND

### Technical Field

The present invention relates to monitoring and maintenance of cyber physical systems (CPS) and more particularly to generating categorical data for missing values in anomaly detection systems.

### Description of the Related Art

Anomaly detection can be used to identify data points, events, or observations that significantly deviate from a normal distribution. Machine learning models can be employed to perform real-time anomaly detection using newly obtained data from an enormous dataset. However, the accuracy of such machine learning models are directly proportional to the quality of training data used to train the models. Training data with accurate data points in the real world is preferred which can include missing values.

### SUMMARY

According to an aspect of the present invention, a computer-implemented method is provided for generating categorical data for missing values in anomaly detection systems, including, aligning irregular time-series data obtained from cyber-physical systems data into regular time-series data by utilizing a generated timestamp sequence to obtain aligned time-series data, filling missing values from the aligned time-series data with generated categorical time-series data, performing anomaly detection for a cyber-physical system to obtain system anomalies, and performing corrective action to resolve issues with the cyber-physical system caused by the system anomalies.

According to another aspect of the present invention, a system is provided for generating categorical data for missing values in anomaly detection systems, including, a memory device, one or more processor devices operatively coupled with the memory device to perform operations, aligning irregular time-series data obtained from cyber-physical systems data into regular time-series data by utilizing a generated timestamp sequence to obtain aligned time-series data, filling missing values from the aligned time-series data with generated categorical time-series data, performing anomaly detection for a cyber-physical system to obtain system anomalies, and performing corrective action to resolve issues with the cyber-physical system caused by the system anomalies.

According to yet another aspect of the present invention, a non-transitory computer program product comprising a computer-readable storage medium including program code for generating categorical data for missing values in anomaly detection systems, wherein the program code when executed on a computer causes the computer to perform, aligning irregular time-series data obtained from cyber-physical systems data into regular time-series data by utilizing a generated timestamp sequence to obtain aligned time-series data, filling missing values from the aligned time-series data with generated categorical time-series data, performing anomaly detection for a cyber-physical system to obtain system anomalies, and performing corrective action to resolve issues with the cyber-physical system caused by the system anomalies.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a flow diagram showing a high-level overview of a computer-implemented method for generating categorical data for missing values in anomaly detection systems, in accordance with one embodiment of the present invention;

FIG. 2 is a block diagram showing a table of the generated timestamps to be matched, in accordance with an embodiment of the present invention;

FIG. 3 is a block diagram showing a system performing downstream tasks for generating categorical data for missing values in anomaly detection systems, in accordance with an embodiment of the present invention;

FIG. 4 is a block diagram showing a computing system for generating categorical data for missing values in anomaly detection systems, in accordance with an embodiment of the present invention;

FIG. 5 is a block diagram showing hardware and software components of a system for generating categorical data for missing values in anomaly detection systems, in accordance with an embodiment of the present invention; and

FIG. 6 is a block diagram showing a structure of deep neural networks for generating categorical data for missing values in anomaly detection systems, in accordance with an embodiment of the present invention.

### DETAILED DESCRIPTION OF PREFERRED EMBODIMENTS

In accordance with embodiments of the present invention, systems and methods are provided for generating categorical data for missing values in anomaly detection systems.

In an embodiment, irregular time-series data can be aligned into regular time-series data by utilizing a generated timestamp sequence to obtain aligned time-series data. Missing values from the aligned time-series data can be filled with generated categorical time-series data. Anomaly detection can be performed for the cyber-physical system to obtain system anomalies. A corrective action can be performed to resolve issues with the cyber-physical system caused by the system anomalies.

The Cyber-Physical System (CPS) entails the deployment of a considerable array of sensors dedicated to monitoring the operational state of the system. In real-world applications, a substantial portion of these sensors yields binary or categorical data rather than numerical readings. The surveillance of CPS health based on such categorical sensor data is important in maintaining proper function of the CPS. Furthermore, within CPS applications, the occurrence of irregularly sampled categorical time-series is prevalent. These time-series are often afflicted by a large number of missing values, thus generated additional challenges and complexities in the tasks of anomaly detection and diagnosis. Unfortunately, there is limited work on exploring missing values and missing patterns in categorical time-series. It is necessary to design a tool to convert sparse and irregular categorical time series into regular categorical time series, thereby further improving the performance of the anomaly detection monitoring system.

Other state-of-the-art time series analysis methods focus on anomaly detection parts and uses forward & backward interpolation method to fill missing values. However, the forward & backward interpolation approach has a strong assumption that categorical sensors report values when the value changes or when the value changes beyond a certain range. However, this assumption usually does not hold. For example, because the computer system's memory is relatively small, it cannot accept values from all sensors at the same time, which can cause missing values. As a result, this approach sometimes adds additional noise to the original features of the data, resulting in sub-par performance of anomaly detection model (sometimes worse than what it was trained on the original data). Additionally, filling gaps in time-series data is a significant challenge for machine learning systems due to at least the following factors: noise, non-linear relationships of data, multi-variable dependencies, and data quality issues.

In this invention, the present embodiments provide a Sparse and Irregular time series Processing Tool (SIPT) that contributes to the efficient and effective management of CPS. The present embodiments utilize limited parameter settings in advance (by default setting) and can be applied to a wide variety of CPS. The present embodiments can be integrated with other operational tools (e.g., anomaly detection systems) to further improve the performance of anomaly detection and diagnosis. The present embodiments can be applied to a large variety of CPSs, e.g., autonomous vehicles, air quality monitoring system, network systems, power plants, vehicles, satellites, etc.

Additionally, the present embodiments utilize a special category to fill missing values. By filling in missing values, the accuracy of the data within the processed dataset is increased. As a result, the computational cost efficiency of training with the processed data is increased, which in turn increases computation cost efficiency for the downstream task.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

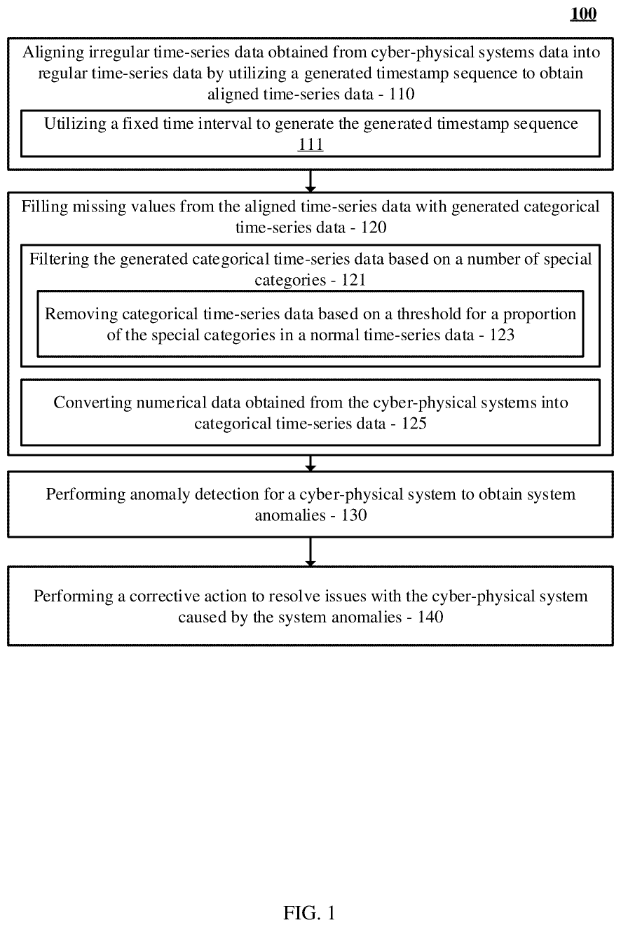

Referring now in detail to the figures in which like numerals represent the same or similar elements and initially to FIG. 1, a flow diagram showing a high-level overview of a computer-implemented method for generating categorical data for missing values in anomaly detection systems, in accordance with one embodiment of the present invention.

In an embodiment, irregular time-series data can be aligned into regular time-series data by utilizing a generated timestamp sequence to obtain aligned time-series data. Missing values from the aligned time-series data can be filled with generated categorical time-series data. Anomaly detection can be performed for the cyber-physical system to obtain system anomalies. A corrective action can be performed to resolve issues with the cyber-physical system caused by the system anomalies.

In block 110, irregular time-series data obtained from cyber-physical systems can be aligned into regular time-series data by utilizing a generated timestamp sequence to obtain aligned time-series data.

To obtain aligned time-series data, block 111 can be performed.

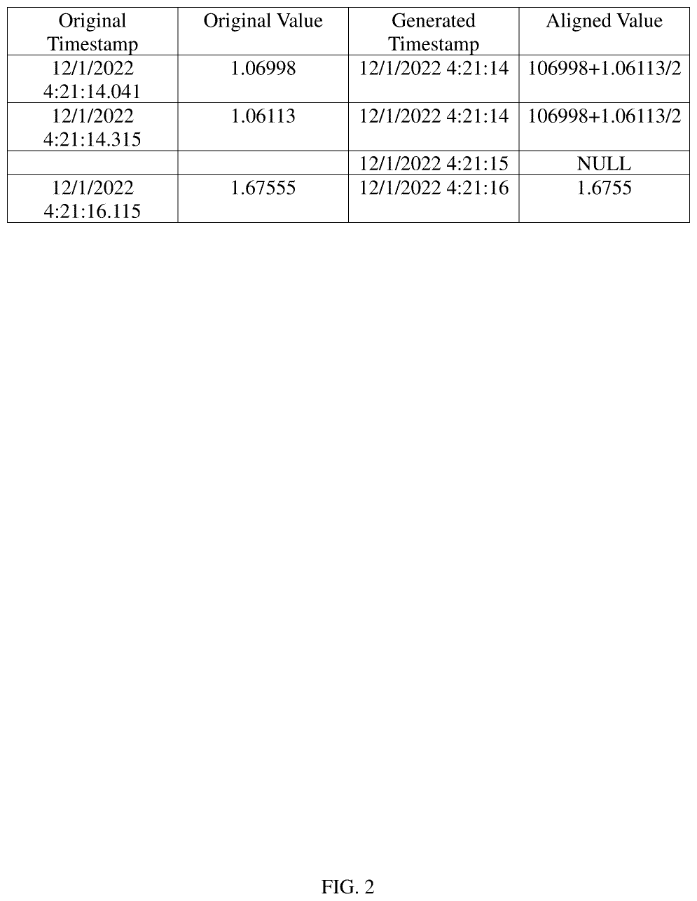

In block 111, a fixed time interval can be utilized to generate the generated timestamp sequence. A time stamp sequence can be generated with a fixed interval (e.g., one second, etc.) based on the time-series data being processed. After generating the timestamp sequence, time-series data obtained from sensors can be aligned to the generated time stamp sequence. If there is a generated timestamp that can be matched to multiple values, the values can be combined to represent these values. FIG. 2 shows an example.

Referring now to FIG. 2, a block diagram showing a table of the generated timestamps to be matched, in accordance with an embodiment of the present invention.

In an example, time-series data and its corresponding values can be obtained from a CPS using sensors. The CPS can be a temperature sensor module within an autonomous vehicle. Other sub-modules of the CPS can generate different time-series data having its corresponding values.

Column 1 refers to the original time stamp of the time series data and column 2 refers to the original value of the time series data. In this table, the time intervals of original time series are not the same.

Column 3 refers to the generated time stamp of the time series data and column 4 refers to the generated value of the time series data. In this table, the time intervals of original time series are the same. The first two values of original time series are matched to the same time window. In an embodiment, the values of the matched rows can be combined (e.g., averaged, etc.) to represent these two values.

Referring now back to FIG. 1. In block 120, missing values from the aligned time-series data can be filled with generated categorical time-series data and obtain an aligned training dataset.

The empty values in the generated time series can be generated with a special category placeholder. The special category placeholder can be generated to fill in the gaps of the obtained data.

Referring now back to FIG. 2, the third row is generated to fill in the gap between the second row and the fourth row. The value of generated timestamp is missing, so a special category placeholder can be inserted in the value column. In FIG. 2, the special category placeholder can be “NULL”. Due to the special category placeholder, more information from the CPS can be obtained such as frequency and duration of the missing values.

In another embodiment, the special category placeholder can be a blob that is pre-programmed with an anomaly detection system to enable cost efficient processing. In another embodiment, the special category placeholder can be generated by a neural network trained to learn the category that would enable cost efficient processing of the anomaly detection system.

Referring back now to FIG. 1. In block 121, filtering the generated categorical time-series data based on a number of special categories in the training data that reduces computational cost efficiency of an anomaly detection system.

To filter the time-series data, categories of the time-series data is processed and evaluated against a threshold for a proportion of the special categories in the normal time-series data.

In block 123, categorical time-series data can be removed based on a threshold for a proportion of the special categories in the normal time-series data.

If there are a large number of special categories in the training data, it is likely that the trained model will be immature, thereby reducing the efficiency of the anomaly detection system. When there are too many special categories, the model may become overly complex and can start to fit the noise in the training data rather than the underlying patterns. Additionally, with a large number of special categories, the training data may become fragmented, making it difficult for the model to identify meaningful patterns and relationships between the data points. For example, if the special values in the training data account for more than 30% of the total data, the model may become immature, leading to an excessive number of false negatives and false positives.

To resolve this issue, a selected categorical time-series data can be removed based on a threshold for a proportion of the special categories in the normal time-series data. The proportion can be calculated as the number of special categories detected over the total number of normal time-series data for a categorical time-series data. The threshold can range from zero to one. For example, a selected threshold can be 0.25 and the proportion for categorical time-series data for engine temperature is 0.3, then the time-series data for engine temperature can be removed. This can be performed iteratively until all time-series data have been processed.

In another embodiment, the categorical time-series data that exceeded the threshold can be masked (e.g., generating “NULL” values for masked data) by using a neural network that can process text. In another embodiment, rule-based approaches can be used to filter the time-series data. The rules can be predefined to replace the values based on specific conditions. In another embodiment, statistical methods can be utilized, such as mean or median imputation, to filter the time-series data.

In block 125, numerical data obtained from the cyber-physical systems can be converted into categorical time-series data.

To convert numerical data obtained from the cyber-physical systems into categorical time-series data, the z-score method can be utilized. The z-score method can include computing for the new value as the result of the difference between the original numerical value and the mean of the numerical values obtained from the sensors over the standard deviation. This can be performed iteratively until all time-series data have been processed.

For example, suppose that the following numerical time series data {22.5,22.7, 23.1, 28.3, 28.4, . . . , 30.5} can be obtained. The z-score for each data point can be calculated and rounded to one decimal place: {22.5 (z-score:−0.8), 22.7 (z-score:−0.8), 23.1 (z-score:−0.7), 28.3 (z-score: 0.2), 28.4 (z-score: 0.2), . . . , 30.5 (z-score: 0.6)}. The data points with the same rounded z-score value are: {−0.8 (22.5, 22.7), −0.7 (23.1), 0.2 (28.3, 28.4), . . . , 0.6 (30.5)} The resulting data is: {−0.8, −0.8, −0.7, 0.2, 0.2, . . . 0.6}. By merging consecutive data points with the same rounded z-score value, the dimensionality of the data can be reduced and the underlying trends and patterns in the data can be preserved.

In another embodiment, threshold-based methods can be employed to convert numerical data into categorical time-series data. Predefined thresholds can be employed to categorize numerical values into different categories. In another embodiment, histogram-based methods can be used. The numerical values can be divided into bins based on a range and each bin can be assigned a categorical label.

A training dataset can then be generated from the processed categorical time-series data. A processing dataset can also be generated from the processed categorical time-series data for downstream tasks such as anomaly detection.

By pre-processing the data, the accuracy and efficiency of anomaly detection systems can be increased by providing a clean and consistent data foundation, which allows for more effective pattern recognition and outlier identification.

In block 130, performing anomaly detection for the cyber-physical system to detect system anomalies.

To perform anomaly detection for the cyber-physical system, an anomaly detection model can be trained using the training dataset. The anomaly detection model can include neural networks (e.g., long short term memory (LSTM), etc.) that can learn relationships between normal categorical time-series data and “anomalous” categorical time-series data. The anomalous categorical time-series data can include missing values, vague values, unexpected number of data for a category, etc.

In an embodiment, histograms can be constructed for each category in the processing dataset. A relationship between the histograms can then be learned by a machine-learning model such as neural networks. The histograms can be clustered together to determine outliers from the normal dataset. The outliers can then be obtained as the system anomalies.

The processing dataset can be utilized for anomaly detection. For example, in a network monitoring system, network logs can be monitored for system vulnerabilities and attacks. The categories for the network logs can include access from an internet protocol (IP) address. A system anomaly can be an unexpected amount of access from a single IP address in a manner of seconds which can explain a distributed denial of service (DDOS) attack. The system anomaly can then be presented to the user in text format that details the entity, the time, event, etc. that caused the system anomaly.

By extracting relevant features from the pre-processed network data, such as the communication pattern between source and destination internet protocol (IP) addresses, these features can be converted into time series data and utilized to detect abnormal patterns (e.g., DDOS attack). If the frequency of the feature exceeds its normal historical range, the present embodiments can generate an alert, notifying the user of a potential network anomaly (e.g., source IP is making frequent requests to destination IP). By pre-processing the dataset, the accuracy and efficiency of anomaly detection systems can be increased by providing a clean and consistent data foundation, which allows for more effective pattern recognition and outlier identification.

In block 140, performing corrective action to resolve issues with the cyber-physical system caused by the system anomalies.

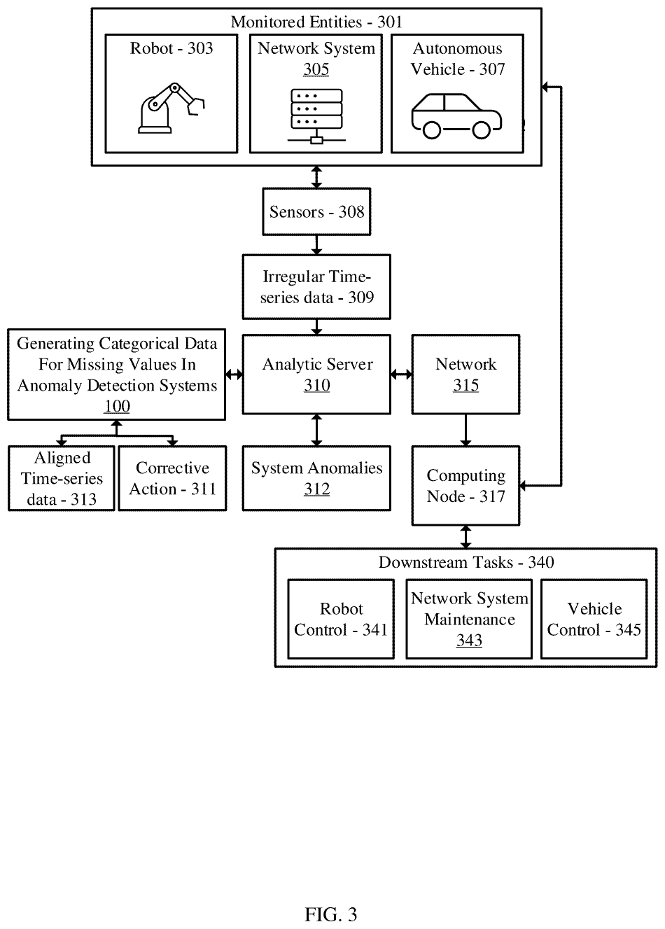

A corrective action can be performed to resolve issues with the CPS caused by the system anomalies. This is shown in more detail in FIG. 3.

Referring now to FIG. 3, a block diagram showing a system performing downstream tasks for generating categorical data for missing values in anomaly detection systems, in accordance with an embodiment of the present invention.

In system 300, monitored entities 301 that include cyber-physical systems such as robot 303, network system 305, autonomous vehicle 307, can be utilized for different processes such as manufacturing, distributed computing system utilization, and autonomous driving, respectively.

Irregular time-series data 309 can be captured by sensors 308 from the monitored entities 301. The irregular time-series data 309 can then be transmitted to an analytic server 310, through a network 315 for processing, which can include generating categorical data for missing values in anomaly detection systems 100 to generate aligned time-series data 313 from irregular time-series data 309 for further processing. The aligned time-series data 313 can then be processed by the analytic server 310 to generate a corrective action 311 for system anomalies 312.

The corrective action 311 can then be transmitted to computing node 317 of the monitored entities 301 through a network 315 to perform downstream tasks 340.

The downstream tasks 340 can include robot control 341, network system maintenance 343 and vehicle control 345.

In robot control 341, irregular time-series data 309 obtained from sensors 308 of a robot 303 can be processed to determine performance metrics of the robot 303. The performance metrics can include physical metrics (e.g., temperature, humidity, etc.), workflow metrics (e.g., stage within processing workflow, etc.). Based on the irregular time-series data 309, system anomalies 312 (e.g., sudden change in physical metrics, workflow metrics, etc.) can be detected. Based on the system anomalies 312, a corrective action 311 can include generating instruction code to control the robot 303 such as stopping the robot, starting a different workflow stage, resuming the robot, etc.

In network system maintenance 343, irregular time-series data 309 obtained from sensors 308 of a network system 305 can be processed to determine performance metrics of the network system 305. The performance metrics can include physical metrics of the physical network (e.g., temperature, humidity, etc.), workflow metrics (e.g., stage within processing workflow performed by the distributed computing system, etc.). Based on the irregular time-series data 309, system anomalies 312 (e.g., sudden change in physical metrics, workflow metrics, etc.) can be detected. Based on the system anomalies 312, a corrective action 311 can include generating instruction code to update configuration settings of the network system 305 such as adding more processing power, adding more container nodes to the network system, blocking packets from incoming IP address detected that caused the system anomaly within a distributed computing system, etc.

In vehicle control 345, irregular time-series data 309 obtained from sensors 308 of an autonomous vehicle 307 can be processed to determine performance metrics of the autonomous vehicle 307. The performance metrics can include physical metrics (e.g., temperature, humidity, etc.), navigational trajectory, relationship with neighboring cars (e.g., distance, speed, etc.). Based on the irregular time-series data 309, system anomalies 312 (e.g., sudden change in physical metrics, navigational trajectory, etc.) can be detected. Based on the system anomalies 312, a corrective action 311 can be generating instruction code to control the autonomous vehicle 307 such as stopping the vehicle, changing direction, turning on the heat to cool the motor, etc. Other downstream tasks are contemplated.

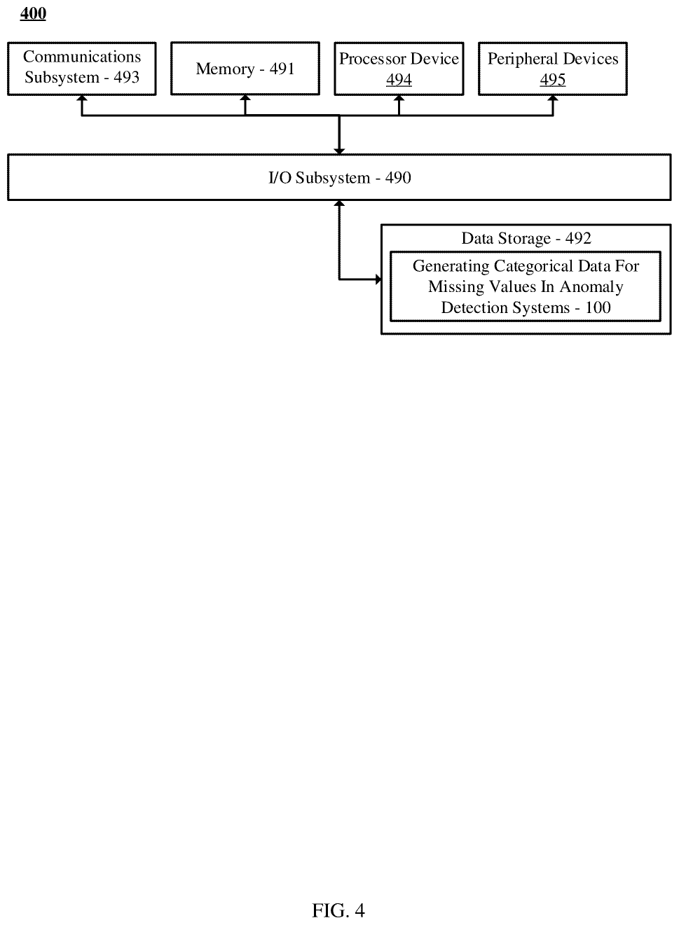

Referring now to FIG. 4, a block diagram showing a computing system for generating categorical data for missing values in anomaly detection systems, in accordance with an embodiment of the present invention.

The computing device 400 illustratively includes the processor device 494, an input/output (I/O) subsystem 490, a memory 491, a data storage device 492, and a communication subsystem 493, and/or other components and devices commonly found in a server or similar computing device. The computing device 400 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 491, or portions thereof, may be incorporated in the processor device 494 in some embodiments.

The processor device 494 may be embodied as any type of processor capable of performing the functions described herein. The processor device 494 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 491 may be embodied as any type of volatile or non-volatile memory or data storage capable of performing the functions described herein. In operation, the memory 491 may store various data and software employed during operation of the computing device 400, such as operating systems, applications, programs, libraries, and drivers. The memory 491 is communicatively coupled to the processor device 494 via the I/O subsystem 490, which may be embodied as circuitry and/or components to facilitate input/output operations with the processor device 494, the memory 491, and other components of the computing device 400. For example, the I/O subsystem 490 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 490 may form a portion of a system-on-a-chip (SOC) and be incorporated, along with the processor device 494, the memory 491, and other components of the computing device 400, on a single integrated circuit chip.

The data storage device 492 may be embodied as any type of device or devices configured for short-term or long-term storage of data such as, for example, memory devices and circuits, memory cards, hard disk drives, solid state drives, or other data storage devices. The data storage device 492 can store program code for generating categorical data for missing values in anomaly detection systems 100. Any or all of these program code blocks may be included in a given computing system.

The communication subsystem 493 of the computing device 400 may be embodied as any network interface controller or other communication circuit, device, or collection thereof, capable of enabling communications between the computing device 400 and other remote devices over a network. The communication subsystem 493 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 400 may also include one or more peripheral devices 495. The peripheral devices 495 may include any number of additional input/output devices, interface devices, and/or other peripheral devices. For example, in some embodiments, the peripheral devices 495 may include a display, touch screen, graphics circuitry, keyboard, mouse, speaker system, microphone, network interface, and/or other input/output devices, interface devices, GPS, camera, and/or other peripheral devices.

Of course, the computing device 400 may also include other elements (not shown), as readily contemplated by one of skill in the art, as well as omit certain elements. For example, various other sensors, input devices, and/or output devices can be included in computing device 400, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing system 400 are readily contemplated by one of ordinary skill in the art given the teachings of the present invention provided herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that can perform one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

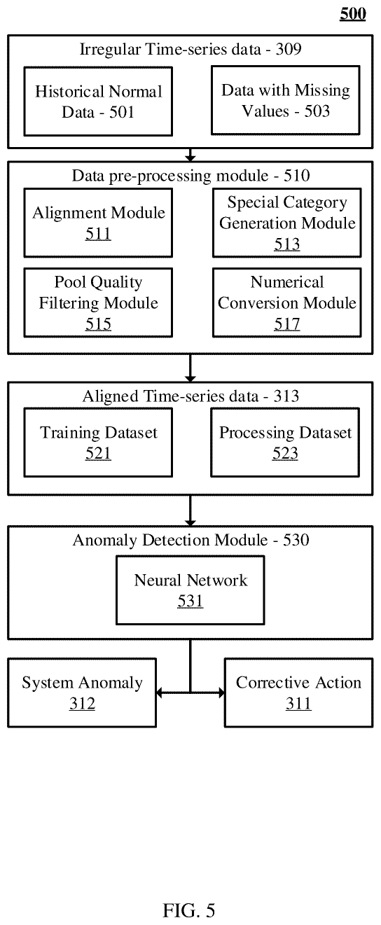

Referring now to FIG. 5, a block diagram showing hardware and software components of a system for generating categorical data for missing values in anomaly detection systems, in accordance with an embodiment of the present invention.

In system 500, irregular time-series data 309 can be processed by a data prep-processing module 510. The irregular time-series data 309 can include historical normal data 501 and data with missing values 503.

The data pre-processing module 510 can encode irregular time-series data 309 into aligned time-series data 313. The data pre-processing module 510 can include an alignment module 511, a special category generation module 513, a pool quality filtering module and a numerical conversion module 517. The alignment module 511 aligns the irregular time-series data 309 based on an interval and its respective values can be combined into a generated time-series data. The special category generation module 513 can generate special category placeholders for missing data in the irregular time series data 309. In an embodiment, the irregular time series data 309 can utilize neural network 531 to generate the special category placeholder. The pool quality filtering module 515 filters the time-series data based on a proportion of special categories generated for a category. The numerical conversion module 517 converts numerical time-series data into categorical time-series data through z-model method.

The aligned time-series data 313 can be utilized for a training dataset 521 and a processing dataset 523. The training dataset 521 utilizes previously pre-processed aligned time-series data 313 to train an anomaly detection module 530 and its neural network 531. The processing dataset 523 is utilized by the anomaly detection module to perform anomaly detection to detect system anomaly 312 and generate corrective action 311 to resolve issues caused by the system anomaly 312.

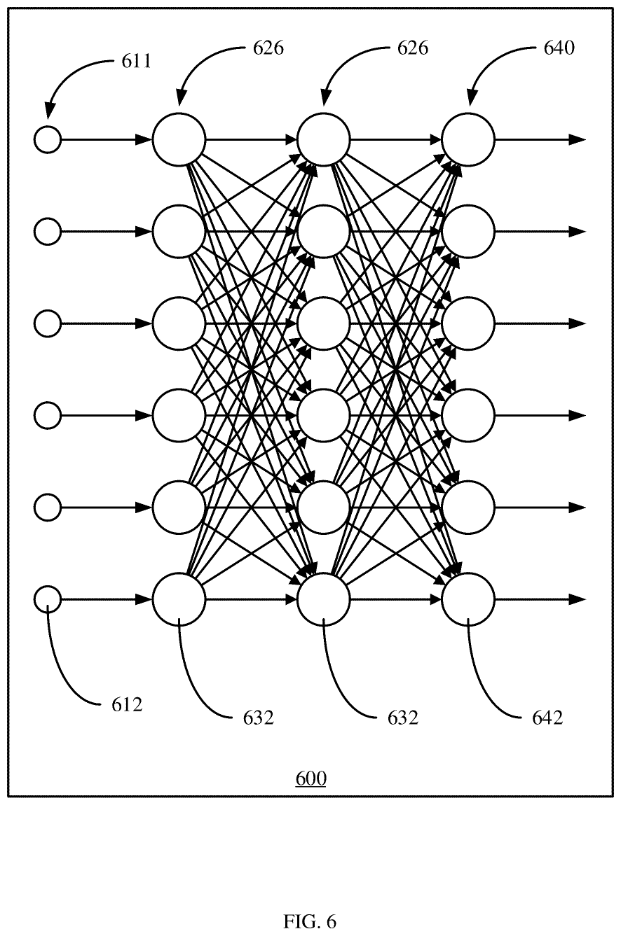

Referring now to FIG. 6, a block diagram showing a structure of deep neural networks for generating categorical data for missing values in anomaly detection systems, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 600, such as a multilayer perceptron, can have an input layer 611 of source neurons 612, one or more computation layer(s) 626 having one or more computation neurons 632, and an output layer 640, where there is a single output neuron 642 for each possible category into which the input example could be classified. An input layer 611 can have a number of source neurons 612 equal to the number of data values 612 in the input data 611. The computation neurons 632 in the computation layer(s) 626 can also be referred to as hidden layers, because they are between the source neurons 612 and output neuron(s) 642 and are not directly observed. Each neuron 632, 642 in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, . . . wₙ₋₁, wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

In an embodiment, the computation layers 626 of the neural network 531 can learn relationships between an aligned time-series data 313 and an irregular time-series data 309 to detect system anomalies 312. The output layer 642 can then generate a prediction of a feature within the irregular time-series data as a system anomaly 312. In another embodiment, the neural network 531 can learn the relationships between system anomalies 312 and a learned method of fixing issues caused by the system anomalies 312. The output layer 642 can then generate corrective action 311 to resolve the issues caused by the system anomalies 312.

Training a deep neural network can involve two phases, a forward phase where the weights of each neuron are fixed and the input propagates through the network, and a backwards phase where an error value is propagated backwards through the network and weight values are updated. The computation neurons 632 in the one or more computation (hidden) layer(s) 626 perform a nonlinear transformation on the input data 612 that generates a feature space. The classes or categories may be more easily separated in the feature space than in the original data space.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for generating categorical data for missing values in anomaly detection systems, comprising:
aligning irregular time-series data obtained from cyber-physical systems data into regular time-series data by utilizing a generated timestamp sequence to obtain aligned time-series data;
filling missing values from the aligned time-series data with generated categorical time-series data;
performing anomaly detection for a cyber-physical system to obtain system anomalies; and
performing a corrective action to resolve issues with the cyber-physical system caused by the system anomalies.

2. The computer-implemented method of claim 1, wherein performing the corrective action further comprises generating instruction code to control an autonomous vehicle to resolve issues caused by the detected system anomaly within the autonomous vehicle.

3. The computer-implemented method of claim 1, wherein performing the corrective action further comprises generating instruction code to block packets from incoming internet protocol (IP) address detected that caused the system anomaly within a distributed computing system.

4. The computer-implemented method of claim 1, wherein aligning the irregular time-series data further comprises utilizing a fixed time interval to generate the generated timestamp sequence.

5. The computer-implemented method of claim 1, wherein filling the missing values further comprises filtering the generated categorical time-series data based on a number of special categories.

6. The computer-implemented method of claim 5, wherein filling the missing values further comprises removing categorical time-series data based on a threshold for a proportion of the special categories in a normal time-series data.

7. The computer-implemented method of claim 1, wherein filling the missing values further comprises converting numerical data obtained from the cyber-physical systems into categorical time-series data.

8. A system for generating categorical data for missing values in anomaly detection systems, comprising:
a memory device;
one or more processor devices operatively coupled with the memory device to perform operations:
aligning irregular time-series data obtained from cyber-physical systems data into regular time-series data by utilizing a generated timestamp sequence to obtain aligned time-series data;
filling missing values from the aligned time-series data with generated categorical time-series data;
performing anomaly detection for a cyber-physical system to obtain system anomalies; and
performing a corrective action to resolve issues with the cyber-physical system caused by the system anomalies.

9. The system of claim 8, wherein performing the corrective action further comprises generating instruction code to control an autonomous vehicle to resolve issues caused by the detected system anomaly within the autonomous vehicle.

10. The system of claim 8, wherein performing the corrective action further comprises generating instruction code to block packets from incoming internet protocol (IP) address detected that caused the system anomaly within a distributed computing system.

11. The system of claim 8, wherein aligning the irregular time-series data further comprises utilizing a fixed time interval to generate the generated timestamp sequence.

12. The system of claim 8, wherein filling the missing values further comprises filtering the generated categorical time-series data based on a number of special categories.

13. The system of claim 12, wherein filling the missing values further comprises removing categorical time-series data based on a threshold for a proportion of the special categories in a normal time-series data.

14. The system of claim 8, wherein filling the missing values further comprises converting numerical data obtained from the cyber-physical systems into categorical time-series data.

15. A non-transitory computer program product comprising a computer-readable storage medium including program code for generating categorical data for missing values in anomaly detection systems, wherein the program code when executed on a computer causes the computer to perform:
aligning irregular time-series data obtained from cyber-physical systems data into regular time-series data by utilizing a generated timestamp sequence to obtain aligned time-series data;
filling missing values from the aligned time-series data with generated categorical time-series data;
performing anomaly detection for a cyber-physical system to obtain system anomalies; and
performing a corrective action to resolve issues with the cyber-physical system caused by the system anomalies.

16. The non-transitory computer program product of claim 15, wherein performing the corrective action further comprises generating instruction code to control an autonomous vehicle to resolve issues caused by the detected system anomaly within the autonomous vehicle.

17. The non-transitory computer program product of claim 15, wherein performing the corrective action further comprises generating instruction code to block packets from incoming internet protocol (IP) address detected that caused the system anomaly within a distributed computing system.

18. The non-transitory computer program product of claim 15, wherein aligning the irregular time-series data further comprises utilizing a fixed time interval to generate the generated timestamp sequence.

19. The non-transitory computer program product of claim 15, wherein filling the missing values further comprises filtering the generated categorical time-series data based on a number of special categories.

20. The non-transitory computer program product of claim 19, wherein filling the missing values further comprises removing categorical time-series data based on a threshold for a proportion of the special categories in a normal time-series data.
